(19) United States
(12) Patent Application Publication
(10) Pub. No.: US 2025/0134253 A1
(43) Pub. Date: May 1, 2025

(54) CONTAINER, PREFERABLY DRAWER

(71) Applicant: Julius Blum GmbH, Hoechst (AT)

(72) Inventor: Joerg REIHS, Waldburg (DE)

(21) Appl. No.: 19/009,344

(22) Filed: Jan. 3, 2025

Related U.S. Application Data
(63) Continuation of application No. PCT/AT2023/060207, filed on Jun. 29, 2023.

(30) Foreign Application Priority Data
Jul. 11, 2022 (AT) A 50503/2022

(51) Int. Cl. A47B 88/90; A47B 88/423

(52) U.S. Cl. CPC A47B 88/941; A47B 88/423

(57) ABSTRACT

A container, preferably a drawer, includes a container base, a container rear wall, and at least one container side wall in the form of a side panel. The side panel includes at least one sheet profile made substantially of metal or plastic with a rear-wall holder made substantially of metal or plastic arranged at least partially within the at least one sheet profile. The container base is connected to the at least one sheet profile, and/or the container rear wall is connected to the rear-wall holder at at least one connection point by at least one nailed connection via a nail.

The present application is a continuation of International Application PCT/AT2023/060207 filed on Jun. 29, 2023. Thus, all of the subject matter of International Application PCT/AT2023/060207 is incorporated herein by reference.

### BACKGROUND OF THE INVENTION

The invention relates to a container, preferably a drawer, comprising a container base, a container rear wall and at least one container side wall in the form of a side panel, wherein the side panel comprises at least one sheet profile made substantially of metal or plastic with a rear wall holder made substantially of metal or plastic arranged at least in regions within the at least one sheet profile. Furthermore, the invention relates to a piece of furniture with a furniture body and at least one such container. The invention further relates to a method for producing such a container.

Such a container is already known from the prior art, wherein the container base is screwed to a container rail arranged on the sheet profile of the container side wall or the side panel and the container rear wall is screwed to the rear wall holder.

A disadvantage of the prior art is that screw connections require preliminary processing steps such as core drilling, thread cutting, etc. and there are high demands on dimensional tolerances in order to fix the components to be connected relative to each other without causing stress and/or distortion. If the tightening torque is too high, the container may be damaged or the lifetime may be reduced. If the tightening torque is insufficient, there is a risk of component parts becoming loose during use of the container. In addition, the container base is pulled against the container rail by a tensile force transmitted via the screw, so that a gap between the container base and the container side wall is accessible from the interior of the container, which reduces the visual appeal of the container and increases the occurrence of dirtying. Furthermore, tests have shown that a large number of screw connections are required to ensure sufficient stability and/or strength of the container for the usual forces exerted on the container during use. In addition, screw connections—for example in the form of nuts, screw heads or the like—require installation space, wherein there is a risk of collisions with other components and the container design may be less compact. Further containers are known from WO 2021/032539 A1, DE 10 2008 024 673 A1, DE 10 2016 120 587 A1 and WO 2011/094772 A1.

### SUMMARY OF THE INVENTION

The object of the present invention is therefore to provide a container that is improved compared to the prior art, as well as a piece of furniture and a method for producing a container, in which the disadvantages of the prior art are at least partially eliminated, and which are characterized in particular by a convenient and quick to produce, secure and firm connection and/or a reduced amount of required connecting means and/or a firm fit of the connected components to reduce dirtying by dirt.

Therefore, according to the invention, the container base is connected to the at least one sheet profile and/or the container rear wall is connected to the rear wall holder at at least one connection point by at least one nailed connection via a nail.

This makes it possible for the manufacturing and/or assembly process of the container to be faster and simpler, as no preparatory processing steps are required and the nail can be conveniently shot or nailed into the container—for example using a nail gun—to create the nailed connection.

The at least one nailed connection offers the advantage that, contrary to the tensile force of the screw in the prior art, a compressive force can be transmitted via the nail-caused, for example, by a collar during the insertion of the nail-so that a play provided due to component tolerances or for assembly purposes can be compensated and a firm connection can be created, wherein dirtying of a visible region of the container in a state of use can be reduced and/or a service life of the container can be increased.

By the at least one nailed connection—in particular by means of a collar between wood and plastic or metal achieved by the at least one nailed connection-a hold between the container base and the container side wall and/or the rear wall holder and the container rear wall can be increased. The components fixed relative to one another via the at least one nailed connection lie particularly favorably against one another at a desired position (preferably in a vertical direction upwards in the use state).

Due to the improved hold of the at least one nailed connection on the container, the number of connection points can be reduced. One nail is sufficient for each rear wall holder. With conventional container side wall extensions, the prior art requires three screws per side panel for the container base, which can be replaced by one nail or a maximum of two nails.

Particularly preferably, the connection points are located at an end region of a container base side edge (and optionally centrally on the container base side edge) and/or centrally on a rear wall holder connection leg.

The container base, container rear wall and container side wall may be parts of a drawer, but are generally not limited to drawers.

The at least one nailed connection can be generated by plastic deformation via displacement of material, wherein a conical penetration of the nail into steel can be achieved by shooting through the solid material with a firm hold.

For example, the at least one nailed connection can connect component parts of the container (apart from the nail) directly in the form of metal to wood or metal to plastic or plastic to plastic or plastic to wood, wherein metal to metal is also conceivable. A connection between wood and wood is generally not provided via the at least one nailed connection.

Another additional positive feature is that standard fittings can be used and no drilling or graining is required on the side panel, the rear wall holder and/or the container base or container rear wall. Preferably, the nail is arranged at the at least one nailed connection substantially flush with adjacent material and can optionally be introduced completely flush and/or with a slight depression relative to the surrounding material by plastic and/or elastic deformation.

The nail is preferably in the form of tempered steel-particularly preferably tempered, annealed and/or galvanized.

Particularly preferably, the metallic material of the rear wall holder and/or of the at least one sheet profile is in the form of steel. In general, however, plastic is also possible for the rear wall holder and/or the at least one sheet profile.

As stated at the outset, protection is also sought for a piece of furniture with a furniture body and at least one such container, wherein the at least one container is mounted displaceably on at least one drawer rail relative to at least one body rail arranged on the furniture body, preferably via at least one container rail, wherein optionally at least one central rail is arranged movably between the at least one drawer rail and the at least one body rail.

If at least one central rail is provided, the container can substantially be fully extended relative to the furniture body. If at least one container rail is provided, a panel hat—generally formed by a single bent sheet profile—can be conveniently connected to the at least one drawer rail and provide a support surface for the drawer base. In general, however, a container rail can be dispensed with.

As stated at the outset, protection is also sought for a method for producing such a container, wherein the following method steps are carried out: The container base, the container rear wall and the at least one container side wall with the at least one sheet profile substantially made of metal or plastic and the rear wall holder substantially made of metal or plastic are provided and the container base is connected to the at least one sheet profile at at least one connection point, preferably via a nail gun, by at least one nailed connection via a nail and/or the container rear wall is connected to the rear wall holder at at least one connection point, preferably via a nail gun, by at least one nailed connection via a nail.

This allows the container to be assembled particularly quickly, with the container being particularly stable and compact and the components being connected particularly firmly and securely to one another, so that, for example, the number of connection points on the rear wall holder and/or the sheet profile can be reduced.

In general, the nailed connection can be generated using a conventional nail gun, wherein the nailed connection can be achieved particularly conveniently and quickly without much effort, which can result in a particularly efficient assembly process. In particular, the manufacturing process can be ensured with a small number of fastening elements such as lock nuts or the like and reduced material expenditure, wherein nails represent particularly economical fastening elements due to the low material requirements and/or do not require any specialist personnel.

In general, alternatively or in addition to a nail gun and/or a manual method of inserting nails, the at least one nailed connection can be carried out fully automatically on a production line.

According to an advantageous embodiment of the invention, the at least one connection point is formed between the container base and a connection web, preferably container rail, of the at least one sheet profile, wherein the connection web is arranged transversely and/or orthogonally to a side wall of the at least one sheet profile, preferably pointing into an interior of the container in a state of use of the container, and/or is detachably connected to the side wall.

The connection web can, for example, be formed directly by a bent sheet profile of the panel hat or be in the form of a container rail in—in particular detachable-connection with the panel hat. The connection web can have a dual function by providing a support for the container base and fixing the container base to the side panel.

Advantageously, the at least one connection point is formed between the container rear wall and a connection leg of the rear wall holder, wherein the connection leg is arranged transversely and/or orthogonally to a side wall of the at least one sheet profile, which preferably points into an interior of the container in a state of use of the container, and/or is detachably connected to the side wall.

The connecting leg can be used to create a particularly stable connection between the container rear wall and the container side wall. The rear wall holder can be inserted into the container side wall—in particular via a profiling and/or a precise fit—and, if necessary, securely fixed to the side panel via a clamp connection and/or screw connection.

It has proven to be advantageous if the container base and/or the container rear wall is made of wood or plastic.

In general, the container base or the container rear wall can also be made of metal—for example in the form of a sheet steel.

According to an advantageous embodiment of the invention, the nail has a longitudinal extension between 13 mm and 20 mm, preferably between 14 mm and 16 mm. These length dimensions ensure secure fixation without the nail accidentally piercing the base or rear wall of the container or causing a dent in a visible area.

Preferably, a nail shaft diameter is between 1 mm and 3 mm, particularly preferably between 1.5 mm and 2.5 mm. Preferably, the nail shaft tip has a ballistic design. It has also proven advantageous that the nail has a nail shaft and a nail head, preferably spaced from the nail shaft by a groove, wherein the nail head is rectangular or elliptical, preferably circular. Preferably, the nail shaft and/or the nail head is made of hardened steel and/or the nail head has a nail head diameter between 2.5 mm and 5.5 mm, particularly preferably between 3.5 mm and 4.5 mm.

With an elliptical or circular nail head, the risk of injury from sharp edges and/or manufacturing-related burrs is reduced. Nails made of hardened steel can prevent unwanted deformation when piercing metal. Due to the nail head diameter, an elastic and/or plastic deformation of the components to be connected can be kept within a desired range, whereby a visual appearance of the container can be increased and/or a substantially flush finish of the nail head with the surrounding material can be generated.

Nail head diameters between 1.5 mm and 2.5 mm-preferably between 1.7 mm and 2.2 mm—are also applicable.

An advantageous variant of the present invention consists in that the nail head comprises at least one notch, preferably in the form of an embossing and/or in the form of two notches oriented orthogonally to one another, for removing the nail from the container, preferably using a screwdriver.

Particularly preferably, the at least one notch is produced during a setting process or by shooting (or generally by inserting the nail such as hammering) via a nail gun on the nail head. In general, the nail head is sufficiently soft compared to the nail shaft to allow the at least one notch to be made in the nail when making the at least one nailed connection. This allows the nail to be flexibly adapted to a desired disassembly tool during the manufacturing process without any preliminary processing.

The at least one notch can also comprise other contours suitable for removal-such as hexagon socket contour, Torx contour, Phillips screwdriver contour, slotted screwdriver contour, Allen contour or the like.

It is particularly preferred that the nail shaft comprises at least one profiling, preferably designed as a corrugation and/or in the form of a thread, for removing the nail from the container, preferably via a screwdriver.

Despite the presence of the at least one profiling, the nail can be nailed or shot into the container (without rotation). In the prior art, the screw must be screwed in via the thread. Unscrewing the nail like a screw is still possible via the at least one profiling.

Particularly preferably, the component parts are detachably connected to one another via the at least one nailed connection by means of the at least one notch and/or the at least one profiling in order to maintain this advantage of possible disassembly without pliers as with conventional screw connections and at the same time to maintain the positive properties of the at least one nailed connection.

According to a preferred embodiment, a front wall holder is arranged at least in some regions within the at least one sheet profile and a container front wall is provided, wherein the container front wall is connected at at least one connection point by at least one nailed connection via a nail, wherein it is preferably provided that a cover layer is applied to the container front wall at least in the region of the at least one connection point.

Furthermore, the container base and/or the container rear wall and/or the rear wall holder and/or the at least one sheet profile is preferably designed to be opening-free and/or depression-free at least in the region of the at least one nailed connection, preferably before a connection by the nail and/or except for a connection opening generated by the nail.

By introducing at least one nailed connection, it is possible to leave the component parts to be connected without openings, such as holes, and/or depressions, such as grains or similar recesses, in the region of the connection point for the nailed connection. This means that such preparatory process steps can be omitted, making the production chain more efficient and/or simpler.

In a further embodiment, in the region of the at least one connection point via the at least one nailed connection, a collar is formed between the container base and the at least one sheet profile and/or between the container rear wall and the rear wall holder. The container base is pressed against the at least one sheet profile and/or the rear wall holder is pressed against the container rear wall. Preferably, in a state of use of the container, the container base is pressed up in the vertical direction relative to the at least one sheet profile by the collar and/or the rear wall holder is pressed in the longitudinal direction relative to the container rear wall.

By the at least one collar, a particularly strong connection can be ensured, wherein a frictional connection along a connection opening and/or a form-fitting connection orthogonally to the connection opening can be generated, preferably by means of a plastic and/or elastic pressing of metal material onto wood material.

According to an advantageous embodiment of the invention, via the at least one nailed connection, preferably by an optional collar, a play between the at least one sheet profile, preferably an optional side wall pointing towards the inner space of the container and/or in a vertical upwards direction in a state of use of the container, can be compensated for by pressure on the container base and/or by tension on the at least one sheet profile.

By at least one nailed connection and, in a particularly effective manner, by at least one collar, component tolerances due to manufacturing and/or clearances intended to simplify assembly can be compensated. For example, material from a container rail can be pressed against the container base via a collar so that the container base is brought into contact with a side wall of the side panel.

If there is no free space between the side wall and the container base when looking into the interior of the container, dirtying of the container during use can be reduced. In general, a gap between the container rail and the container base can be covered by other components, thus further reducing dirtying of the container.

Preferably, the nail is dismantled from the container, preferably by a screwdriver, via at least one notch arranged on a nail head and/or via at least one profiling arranged on a nail shaft.

This means that the container can be dismantled after assembly despite the at least one nailed connection, for example to carry out maintenance or servicing work, which can increase the service life of the container. Usually, in the case of nailed connections, the nail has to be laboriously removed using pliers, but the at least one notch and/or at least one profiling (such as a thread that can be shot into the material) allows for user-friendly disassembly using a screwdriver.

Furthermore, preferably in a preparatory method step immediately before the introduction of the at least one nailed connection, the container base and/or the container rear wall and/or the rear wall holder and/or the at least one sheet profile is provided without openings and/or without depressions at least in the region of the at least one nailed connection, preferably before a connection by the nail and/or except for a connection opening to be generated via the nail.

It is particularly preferable that in course of the introduction of the at least one nailed connection in the region of the at least one connection point via the at least one nailed connection, a collar is formed between the container base and the at least one sheet profile and/or between the container rear wall and the rear wall holder, wherein the container base is pressed against the at least one sheet profile and/or the rear wall holder is pressed against the container rear wall, wherein it is preferably provided that in a state of use of the container, the container base is pressed up in the vertical direction relative to the at least one sheet profile by the collar and/or the rear wall holder is pressed in the longitudinal direction relative to the container rear wall.

According to an advantageous embodiment, by the at least one nailed connection, preferably by an optional collar, a play which is present between the at least one sheet profile, preferably a side wall and/or in a state of use of the container, which is directed upwards in a vertical direction, is compensated by pressure on the container base and/or by tension on the at least one sheet profile.

It is particularly preferred that at least one notch is provided in a nail head of the nail during the provision of the at least one nailed connection, preferably using a nail gun.

### BRIEF DESCRIPTION OF THE DRAWINGS

Further details and advantages of the present invention are explained in more detail below based on the description of the embodiments shown in the drawings, in which:

FIG. 1 shows a container according to a particularly preferred embodiment before the introduction of nailed connections in a perspective exploded view,

FIG. 2 shows the container according to the exemplary embodiment of FIG. 1 in assembled state with six nailed connections in a perspective view as well as an enlarged detail of a nailed connection,

FIG. 3 shows the container according to the exemplary embodiment of FIG. 2 in a view from below, a sectional view from the front and an enlarged detailed view in the area of a nailed connection,

FIG. 4 shows three preferred embodiments of a nail for use in a nailed connection on the container, each in a perspective view,

FIG. 5 shows the container according to the exemplary embodiment of FIG. 2 in a manufacturing method via a nail gun, wherein a container base is connected to a container side wall, in a perspective view,

FIG. 6 shows the container according to the exemplary embodiment of FIG. 2 in a manufacturing method via a nail gun, wherein a container rear wall is connected to a rear wall holder, in a perspective view,

### DETAILED DESCRIPTION OF THE INVENTION

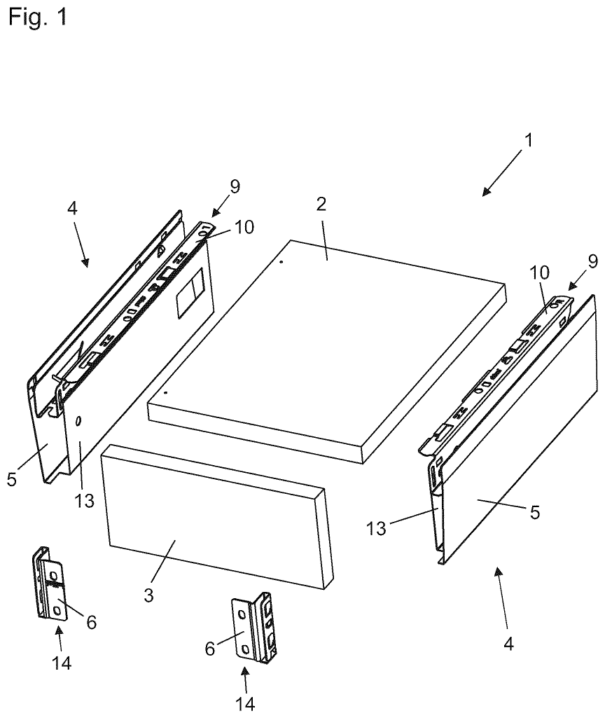

FIG. 1 shows a container 1 in the form of a drawer in an exploded view, wherein the container 1 comprises a container base 2, a container rear wall 3 and two container side walls 4 in the form of side panels.

The side panels or the container side walls 4 each comprise a sheet profile 5 in the form of a container rail 10, a sheet profile 5 comprising a side wall 13, wherein the side wall 13 is arranged substantially parallel to an outer wall of the container side wall 4.

The sheet profiles 5 are made of metal in the form of steel. Two rear wall holders 6 which can be arranged in regions within the sheet profiles 5 are made of metal. In general, the sheet profiles or the rear wall holders 6 can also be made of plastic.

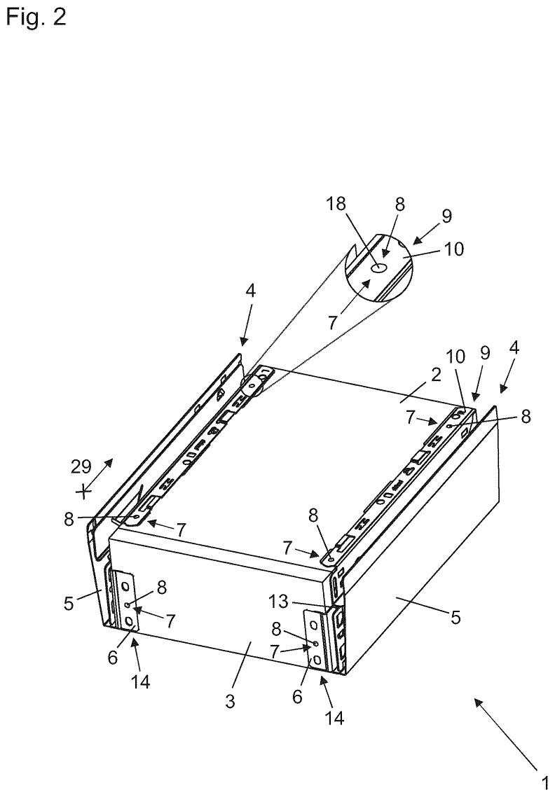

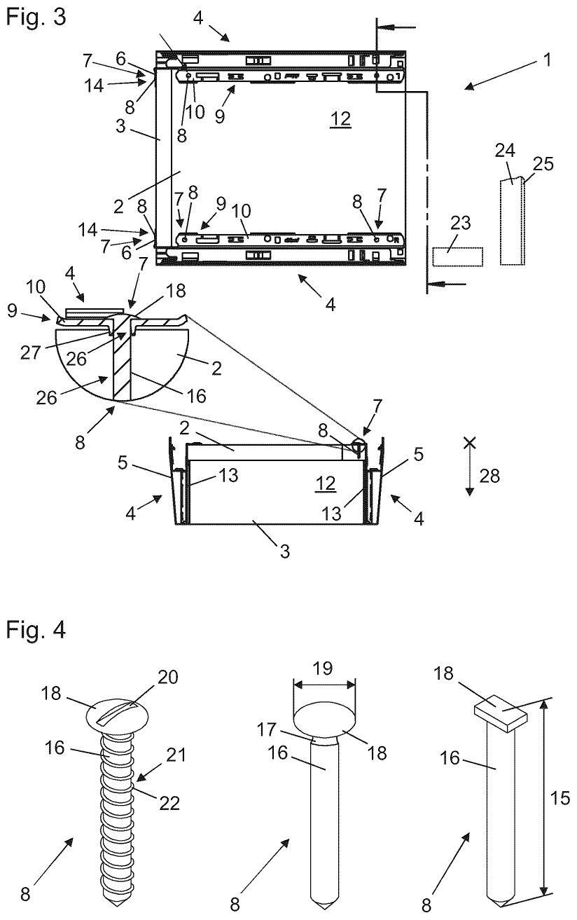

The container base 2, the container rear wall 3, the two rear wall holders 6 and the sheet profiles 5 are designed to be opening-free and depression-free in the area of the nailed connections 7 to be introduced (cf. FIG. 2) before a connection by nails 8 and except for the connection openings 26 generated via the nails 8 (see FIG. 3). The number of nails to be inserted is generally arbitrary and can vary depending on the structural dimensions of the container 1.

FIG. 2 shows the container 1 in the assembled state with six nailed connections 7, wherein it can be seen in the enlarged detail section that the nail head 18 is arranged substantially flush with the container side wall 4. In an analogous manner, the nail head 18 on the rear wall holder 6 is arranged substantially flush with the rear wall holder 6, wherein, for example, an elastic or plastic deformation due to the force acting during the insertion process of the nail 8 can be used for the substantially flush arrangement.

The container base 2 and the container rear wall 3 are made of wood, although in general plastic or metal, for example, can also be used as a material.

The container base 2 is connected to the container rail 10 of the container side wall 4 and the container rear wall 3 is connected to the rear wall holders 6 at a plurality of connection points by nailed connections 7 via nails 8. In general, (at least) one nailed connection 7 can be provided only on the container base 2 or the container rear wall 3.

The connection points are formed between the container base 2 and a respective connection web 9 in the form of the container rail 10 as a sheet profile 5 (connected to the sheet profile 5 in the form of the side wall 13 of the panel hat). The connection webs 9 are arranged transversely and orthogonally to the side wall 13 of the sheet profile 5, which in a state of use of the container 1 points into an interior space 12 of the container 1, and are detachably connected to the side wall 13.

Further connection points are formed between the container rear wall 3 and a connection leg 14 of the rear wall holder 6, wherein the connection leg 14 is arranged transversely and orthogonally to the side wall 13 of the side panel pointing into the interior 12 of the container 1 (see FIG. 3) in the state of use of the container 1 and is detachably connected to the side wall 13. FIG. 3 shows the container 1 at the top in a view rotated by 180° relative to the state of use, wherein a section line is drawn through a nailed connection 7 between the container base 2 and the container side wall 4. The sectional view is shown below with an enlarged detail in the region of nail 8.

In the enlarged detail of the nailed connection 7, it can be seen that in the course of inserting the nailed connection 7 in the region of the connection point via the nailed connection 7, a collar 27 was formed between the container base 2 and the sheet profile 5—formed by the container rail 10 in connection to the panel hat of the side panel.

The container base 2 is pressed by the collar 7 onto the sheet profile 5—formed by the side wall 13 of the panel hat of the side panel-, wherein in a state of use of the container 1, the container base 2 is pressed up in the vertical direction 28 relative to the side wall 13 of the sheet profile 5 by the collar 27.

Via the nailed connection 7 and the collar 27, a play between the side wall 13 of the sheet profile 5—facing the interior 12 of the container 1 and the container base 1 in the vertical direction 28 from above—is compensated in the vertical direction 28 upwards by pressure on the container base 2. Dirtying between the interior 12 and the side wall 13 is reduced by at least linear (or planar) contact between the side wall 13 and the container base 2.

Such a collar 27 is also present between the rear wall holder 6 and the container rear wall 3, wherein the rear wall holder 6 is pressed in the longitudinal direction 29 relative to the container rear wall 3.

The rear wall holder 6 is pressed onto the container rear wall 3 via the nailed connection 7 and the collar 27, wherein in particular production-related component tolerances and/or clearances provided to simplify assembly can be compensated.

In the enlarged detail section, it can be seen that by inserting the nail 8, a connection opening 26 is formed within the container base 2 (as well as the container rear wall 3) and the container side wall 4 (as well as the rear wall holder 6), which was not present before the nail 8 was inserted. It is schematically shown in dashed lines that the container 1 comprises a front wall holder 23 for arrangement at least in regions within the sheet profiles 5 and a container front wall 24, wherein the container front wall 24 can be connected to the front wall holder 23 of the container side wall 4 at least at one connection point via nailed connections 7 by a nail 8. In order to improve the aesthetic appearance of the visible container front wall 24, a cover layer 25 is attached to the container front wall 24 in the region of the connection point after the nailed connections 7 have been introduced.

FIG. 4 shows three exemplary embodiments of nails 8, wherein the features of one embodiment are applicable to the other two embodiments.

The nail 8 shown on the left comprises a nail head 18 and a nail shaft 16, wherein an elongated notch 20 is provided as an embossing or machined groove in order to be able to remove the nail 8 from the container 1 using a screwdriver. The nail head 18 is circular in cross-section.

The nail shaft 16 and the nail head 18 are made of hardened steel. The notch 20 of the nail head 18 was introduced into the nail head 18 by a nail gun 32 during the setting of the nail 8 by means of plastic deformation in the sense of an embossing.

The nail shaft 16 comprises a profiling 21 in the form of a thread 22 in order to be able to remove the nail 8 from the container using a screwdriver. In general, the profiling 21 can also be designed in the form of a corrugation—in particular in contrast to a thread.

The nail 8 shown in the middle comprises a nail head 18 spaced from the nail shaft 16 by a groove 17, wherein the nail head is elliptical in shape. The nail head 18 has a nail head diameter 19 between 3.5 mm and 4.5 mm.

The nail 8 shown on the right has a longitudinal extent 15 between 14 mm and 16 mm. The nail head 18 of this nail 8 is rectangular.

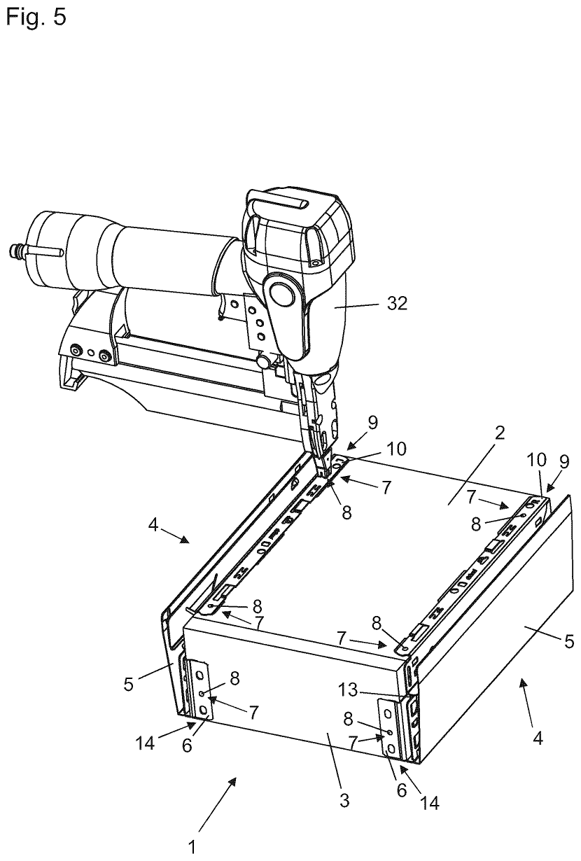

FIG. 5 shows the container 1 during the introduction of a nailed connection 7 between the container rail 8, which is detachably arranged on the panel hat of the side panel (in general, a material connection is also possible), and the container base 2 via a nail gun 32. In general, the nailed connection 7 can also be introduced manually or fully automatically on a system.

A method for producing the container 1 can be illustrated as follows by way of example—without any mandatory chronological connection:
in a preparatory step immediately before the nailed connections 7 are introduced, the container base 2, the container rear wall 3, the rear wall holders 6 and the sheet profiles 5 are provided without openings and without depressions in the regions of the intended nailed connections 7 before the connection by nails 8 and except for the connection openings 26 to be generated via the nails 8, wherein the two container side walls 4 with the sheet profiles 5 are made of metal or plastic and the rear wall holder 6 is made of metal or plastic,
the container base 2 is connected to the sheet profiles 5 (via the container rail 10, although this is not mandatory) at a plurality of connection points via a nail gun 32 by nailed connections 7 via a respective nail 8, and the container rear wall 3 is connected to the rear wall holder 6 at one respective connection point via the nail gun 32 by nailed connections 7 via a respective nail 8.

If disassembly of the container 1 is desired, the nail 8 can be removed from the container 1, for example by means of a screwdriver via a notch 20 arranged on a nail head 18 (not shown in the illustration for reasons of clarity-see FIG. 4) or via a profiling 21 arranged on the nail shaft 16.

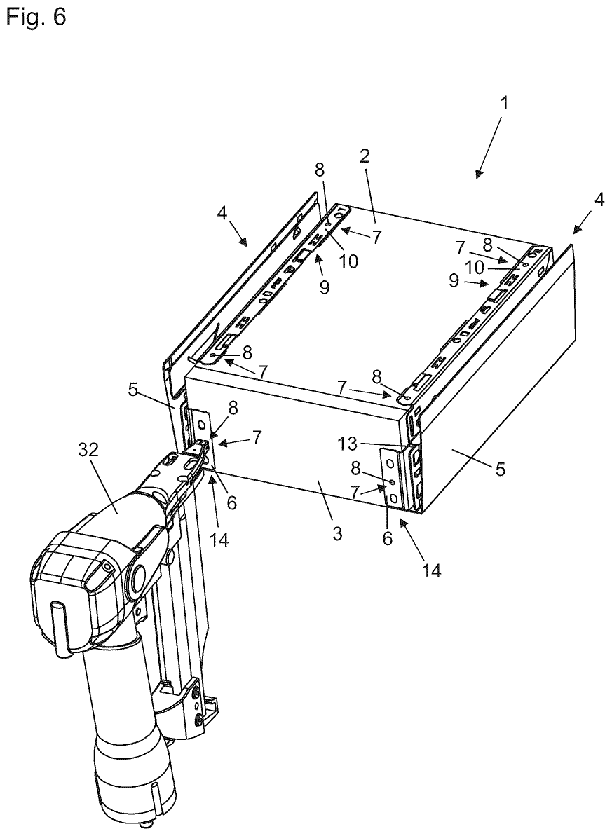

FIG. 6 differs from FIG. 5 only in that the nail gun 32 is used during the introduction of a nailed connection 7 between the rear wall holder 6 and the container rear wall 3.

In general, it is possible to connect only the rear wall holders 6 to the container rear wall 3 or the container side walls 4 to the container base 2 via nailed connections 7. However, it is particularly preferred to provide (at least a respective one) nailed connection 7 on all of these component parts.

After the nailed connections 7 have been inserted into the container 1, the container is ready to be connected to a piece of furniture with a furniture body, wherein the container 1 can be movably mounted via the container rails 10 on drawer rails relative to body rails arranged on the furniture body and, if necessary, a central rail can be movably arranged between the drawer rails and the body rails.

1. A container, preferably a drawer, comprising:
a container base,
a container rear wall, and
at least one container side wall in the form of a side panel, the side panel comprising at least one sheet profile made substantially of metal or plastic with a rear wall holder made substantially of metal or plastic arranged at least in regions within the at least one sheet profile,
wherein the container base is connected to the at least one sheet profile and/or the container rear wall is connected to the rear wall holder at at least one connection point by at least one nailed connection via a nail.

2. The container according to claim 1, wherein the at least one connection point is formed between the container base and a connection web, preferably container rail, of the at least one sheet profile, wherein the connection web is arranged transversely and/or orthogonally to a side wall of the at least one sheet profile, preferably pointing into an interior space of the container in a state of use of the container, and/or is detachably connected to the side wall.

3. The container according to claim 1, wherein the at least one connection point is formed between the container rear wall and a connection leg of the rear wall holder, wherein the connection leg is arranged transversely and/or orthogonally to a side wall of the at least one sheet profile, preferably pointing into an interior space of the container in a use state of the container, and/or is detachably connected to the side wall.

4. The container according to claim 1, wherein the container base and/or the container rear wall are made of wood or plastic.

5. The container according to claim 1, wherein the nail has a longitudinal extent between 13 mm and 20 mm, preferably between 14 mm and 16 mm.

6. The container according to claim 1, wherein the nail has a nail shaft and a nail head, preferably spaced from the nail shaft by a groove, wherein the nail head is rectangular or elliptical, preferably circular, wherein it is preferably provided that the nail shaft and/or the nail head is made of hardened steel and/or the nail head has a nail head diameter between 2.5 mm and 5.5 mm, particularly preferably between 3.5 mm and 4.5 mm.

7. The container according to claim 6, wherein the nail head comprises at least one notch, preferably present as an embossing and/or in the form of two notches oriented orthogonally to one another and/or designed as a hexagon socket or Torx contour, for removing the nail from the container, preferably via a screwdriver.

8. The container according to claim 6, wherein the nail shaft comprises at least one profiling, preferably designed as a corrugation and/or in the form of a thread, for removing the nail from the container, preferably via a screwdriver.

9. The container according to claim 1, wherein a front wall holder is arranged at least in some regions within the at least one sheet profile and a container front wall is provided, wherein the container front wall is connected at at least one connection point by at least one nailed connection via a nail, wherein it is preferably provided that at least in the region of the at least one connection point a cover layer is attached to the container front wall.

10. The container according to claim 1, wherein the container base and/or the container rear wall and/or the rear wall holder and/or the at least one sheet profile is designed to be opening-free and/or depression-free at least in the region of the at least one nailed connection, preferably before a connection by the nail and/or except for a connection opening generated via the nail.

11. The container according to claim 1, wherein in the region of the at least one connection point via the at least one nail connection a collar is formed between the container base and the at least one sheet profile and/or between the container rear wall and the rear wall holder, wherein the container base is pressed against the at least one sheet profile and/or the rear wall holder is pressed against the container rear wall, wherein it is preferably provided that, in a state of use of the container, the container base is pressed up in the vertical direction relative to the at least one sheet profile and/or the rear wall holder is pressed in the longitudinal direction relative to the rear wall of the container by the collar.

12. The container according to claim 1, wherein by means of the at least one nailed connection, preferably by means of an optionally present collar, a play between the at least one sheet profile, preferably an optional side wall pointing into an interior space of the container in a state of use of the container and/or in a state of use of the container in the vertical direction upwards, can be compensated by pressure on the container base and/or by tension on the at least one sheet profile.

13. A piece of furniture with a furniture body and at least one container according to claim 1, wherein the at least one container is mounted displaceably on at least one drawer rail relative to at least one body rail arranged on the furniture body, preferably via at least one container rail, wherein optionally at least one central rail is arranged movably between the at least one drawer rail and the at least one body rail.

14. A method for producing a container according to claim 1, comprising:
providing the container base, the container rear wall, and the at least one container side wall with the at least one sheet profile substantially made of metal or plastic and the rear wall holder substantially made of metal or plastic, and
connecting the container base to the at least one sheet profile at at least one connection point, preferably via a nail gun, by at least one nailed connection via a nail, and/or connecting the container rear wall to the rear wall holder at at least one connection point, preferably via a nail gun, by at least one nailed connection via a nail.

15. The method according to claim 14, wherein the nail is removed from the container, preferably by means of a screwdriver, via at least one notch arranged on a nail head and/or via at least one profiling arranged on a nail shaft.

16. The method according to claim 14, wherein, in a preparatory step immediately before the introduction of the at least one nailed connection, the container base and/or the container rear wall and/or the rear wall holder and/or the at least one sheet profile are provided without openings and/or without depressions at least in the region of the at least one nailed connection, preferably before a connection by the nail and/or except for a connection opening to be generated via the nail.

17. The method according to claim 14, wherein in the course of the introduction of the at least one nailed connection in the region of the at least one connection point via the at least one nailed connection, a collar is formed between the container base and the at least one sheet profile and/or between the container rear wall and the rear wall holder, wherein the container base is pressed against the at least one sheet profile and/or the rear wall holder is pressed against the container rear wall, wherein it is preferably provided that, in a state of use of the container, the container base is pressed up in the vertical direction relative to the at least one sheet profile and/or the rear wall holder is pressed in the longitudinal direction relative to the rear wall of the container by the collar.

18. The method according to claim 14, wherein by the at least one nailed connection, preferably by means of an optionally present collar, a play between the at least one sheet profile, preferably a side wall and/or in a state of use of the container in the vertical direction upwards, is compensated by pressure on the container base and/or by tension on the at least one sheet profile.

19. The method according to claim 14, wherein at least one notch is introduced into a nail head of the nail during the introduction of the at least one nailed connection, preferably via a nail gun.
